(19) United States
(12) Patent Application Publication
(10) Pub. No.: US 2009/0150945 A1
(43) Pub. Date: Jun. 11, 2009

(54) METHOD AND APPARATUS FOR PROVIDING VIDEO-ON-DEMAND SERVICE BASED ON INTERNET PROTOCOL (IP) MULTIMEDIA SUBSYSTEM

(75) Inventors: Heuk Park, Daejeon (KR); Soon-seok Lee, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications, Daejeon (KR)

(21) Appl. No.: 12/137,967

(22) Filed: Jun. 12, 2008

(30) Foreign Application Priority Data
Dec. 7, 2007 (KR) 10-2007-0127157

(51) Int. Cl. H04N 7/173

(52) U.S. Cl. 725/87

(57) ABSTRACT

A method and apparatus for providing a video-on-demand (VOD) service are provided. The VOD service providing method includes: receiving a media setup request message from a user terminal, converting the media setup request message using a second protocol which is different from a first protocol on which the media setup request message is based, transmitting the converted media setup request message through a transmission network, receiving a response message in response to the converted media setup request message through the transmission network, converting the response message using the first protocol on which the media setup request message is based, and transmitting the response message to the user terminal; and converting the converted media setup request message received through the transmission network using the first protocol on which the media setup request message is based, transmitting the newly converted media setup request message to a VOD streaming server, converting the response message from the VOD streaming server using the second protocol, and transmitting the converted response message through the transmission network. Therefore, by preventing overlap of control processes, which may both be initiated when two protocols are used together, it is possible to efficiently perform controlling of a VOD service.

### CROSS REFERENCE TO RELATED APPLICATIONS

This application claims priority from Korean Patent Application No. 10-2007-0127157, filed on Dec. 7, 2007, the disclosure of which is incorporated herein in its entirety by reference.

### BACKGROUND OF THE INVENTION

1. Field of the Invention

The present invention relates to a video-on-demand (VOD) service, and more particularly, to a method and apparatus for providing a video-on-demand (VOD) service in an Internet Protocol Television (IPTV) system.

This work was supported by the IT R&D program of Ministry of Information and Communication (MIC)/Institute for Information Technology Advancement (IITA) [2006-S-064-02, BcN Network Engineering].

2. Description of the Related Art

Internet Protocol Television (IPTV) is a communication/broadcasting integration service which provides an interactive data service as well as a digital channel broadcast, through a Broadcast convergence Network (BcN).

Also, video-on-demand (VOD) is a service which allows a user to directly select and watch at any time and any where programs stored in a video server, which is different to the existing method of only receiving TV programs sent from a broadcasting station. The VOD service is a representative service which can be provided by an IPTV.

Meanwhile, in order to provide a VOD service, a service control layer and a transmission control layer should be implemented in a user terminal and a network apparatus for service approval, billing, management of QoS, etc. An Internet Protocol Multimedia Subsystem (IMS) is expected to be mainly used as a network apparatus in a service layer. The IMS is a standardized Internet Protocol (IP) and Session Initiation Protocol (SIP) based multimedia network which has been discussed in a third generation partnership project (3GPP) which is the standardization organization of W-CDMA. The structure of the IMS is a group of IMS network functions which are supplied after being standardized and modulized by one or more device providers. Also, the IMS is independent from access networks and accelerates the convergence of wired/wireless networks.

The IMS uses session initiation protocol (SIP) as an interface between the IMS and users. In order to control media streaming of a VOD server, a Realtime Streaming Protocol (RTSP) is used.

However, a control process in which no overlapping of control operations occurs while using the functions of the IMS when a VOD service based on an RTSP is provided, has not been disclosed. This is because it is difficult to smoothly match parts where a protocol for media setup of RTSP and SIP function overlap.

In order to solve the problem, there has been a proposal for integrating SIP with RTSP, but it is expected that the proposal will make the SIP complicated.

Accordingly, a method has been used which performs IMS functions, such as user approval, service approval, billing, maintenance of QoS, etc., using SIP, and performs media adjustment using an RTSP independently to performing the IMS functions.

However, since the conventional method requires a process of approving media in a setup process when an RTSP is used independently, even if the media has been already approved by an IMS, and needs to retransmit a protocol for set-up of the media which has been already approved, a delay due to the transmission is generated and a service may be delayed due to the delay.

### SUMMARY OF THE INVENTION

The present invention provides a method and apparatus for providing a video-on-demand (VOD) service in an Internet Protocol Television (IPTV) based on an Internet Protocol Multimedia Subsystem (IMS), which can remove inefficiency caused by using both a Realtime Streaming Protocol (RTSP) and Session Initiation Protocol (SIP), while sufficiently using the functions of the IMS, by selectively using the RTSP and the SIP according to predetermined conditions, when the VOD service is provided.

According to an aspect of the present invention, there is provided a method of providing a video-on-demand (VOD) service, including: receiving a media setup request message from a user terminal, converting the media setup request message using a second protocol which is different from a first protocol on which the media setup request message is based, transmitting the converted media setup request message through a transmission network, receiving a response message in response to the converted media setup request message through the transmission network, converting the response message using the first protocol on which the media setup request message is based, and transmitting the response message to the user terminal; and converting the converted media setup request message received through the transmission network using the first protocol on which the media setup request message is based, transmitting the newly converted media setup request message to a VOD streaming server, converting the response message from the VOD streaming server using the second protocol, and transmitting the converted response message through the transmission network.

The method further includes controlling reproduction of media requested by the user terminal according to the first protocol after the media setup is performed.

According to another aspect of the present invention, there is provided a protocol conversion apparatus for providing a video-on-demand (VOD) service, including: a first protocol converter converting a media setup request message transmitted from a user terminal using a second protocol which is different from a first protocol on which the media setup request message is based, transmitting the converted media setup request message through a transmission network, converting a response message which responds to the media setup request message, using the first protocol, and transmitting the converted response message to the user terminal; and a second protocol converter converting the converted media setup request message received through the transmission network using the first protocol, transporting the newly converted media setup request message to a VOD streaming server, converting a response message which responds to the media setup request message, using the second protocol, and transmitting the converted response message through the transmission network.

According to another aspect of the present invention, there is provided an apparatus for providing a video-on-demand (VOD) service, including: a protocol conversion apparatus performing protocol conversion between a Realtime Streaming Protocol (RTSP) and Session Initiation Protocol (SIP); an Internet Protocol (IP) multimedia subsystem receiving a media setup request message based on the SIP, which is converted by the protocol conversion apparatus; and a VOD application server receiving the media setup request message based on the SIP from the IP multimedia subsystem, transmitting the media setup request message to a VOD application server to select a VOD streaming server, and redirecting the media setup request message to the VOD streaming server so that the user terminal and the VOD streaming server perform call setup.

Therefore, by converting a media setup command based on an RTSP used generally to provide a VOD service into a command for setting up a SIP call, and transmitting the SIP call setup command when an IPTV control system based on IMS is configured, it is possible to solve a problem which can be generated when an RTSP is independently used.

That is, by converting a media setup process based on an RTSP into a process based on SIP to perform media setup through an IMS, it is possible to remove overlapping of control processes caused by using two protocols of the RTSP and SIP which use the functions of the IMS.

Additional aspects of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a block diagram of an apparatus for providing a video-on-demand (VOD) service using conversion between Realtime Streaming Protocol (RTSP) and Session Initiation Protocol (SIP), according to an embodiment of the present invention;

FIG. 2A shows data flow in a media setup method based on an RTSP, according to an embodiment of the present invention;

FIG. 2B shows data flow in a media setup method based on SIP, according to an embodiment of the present invention;

FIG. 3 shows data flow in a method of performing conversion between SIP and an RTSP when the RTSP performs media setup, according to an embodiment of the present invention; and

FIG. 4 is a flowchart of a method of providing a VOD service, according to an embodiment of the present invention.

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

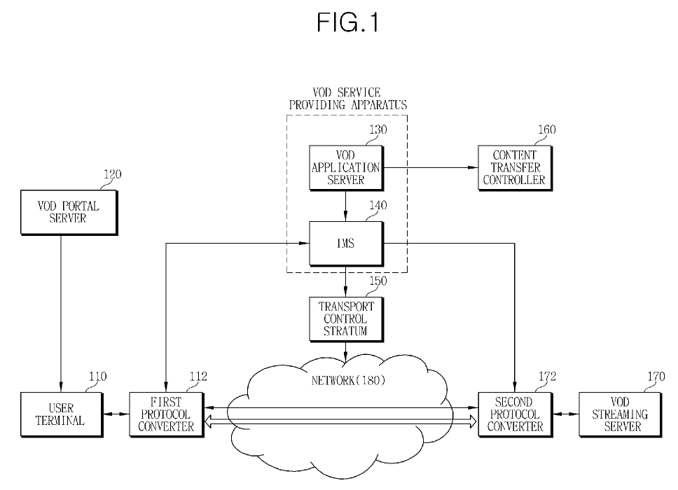

FIG. 1 is a block diagram of an apparatus for providing a video-on-demand (VOD) service using conversion between a Realtime Streaming Protocol (RTSP) and Session Initiation Protocol (SIP), according to an embodiment of the present invention.

A service control method according to an embodiment of the present invention will be described in detail with reference to FIG. 1. First, a user terminal 110 receives various parameters from a VOD portal server 120, in response to the user's request for VOD content. That is, by allowing a user to browse a content list of VOD content and select his or her desired content from the content list, the user terminal 110 receives parameters related to selection of the content or controlling reproduction of the content, etc. from the VOD portal server 120.

The user terminal 110 creates an RTSP DESCRIBE command based on the received parameters, and transfers the RTSP DESCRIBE command to a first protocol converter 112. The first protocol converter 112 may be installed in the user terminal 110, and performs conversion between SIP and an RTSP. The first protocol converter 112 converts the RTSP DESCRIBE command into a SIP INVITE command, and transmits the SIP INVITE command to an Internet Protocol Multimedia Subsystem (IMS) 140.

Since the SIP INVITE command is set to be transferred to a VOD application server 130 with reference to a Home Subscriber Server (HSS) when the user terminal 110 is registered, the IMS 140 transmits the SIP INVITE command to the VOD application server 130 according to the setting.

The VOD application server 130 checks the user's authority, requests a content transfer controller 160 to select an appropriate VOD streaming server 170 according to the location and content of the user terminal 110, and receives the result of the selection by the content transfer controller 160. The VOD application server 130 changes a receiver of the SIP INVITE command to a receiver which indicates content stored in the VOD streaming server 170 selected by the content transfer controller 160, and transfers to the IMS 140 the SIP INVITE command whose receiver has changed.

The IMS 140 transfers the SIP INVITE command to the VOD streaming server 170 via a second protocol converter 172. The second protocol converter 172 converts the SIP INVITE command into an RTSP command, and transmits the RTSP command to the VOD streaming server 170. The second protocol converter 172 may be installed in the VOD streaming server 170.

If the IMS 140 receives a SIP OK command from the second protocol converter 172, the IMS 140 transfers a transport parameter to a transport control stratum 150, and the transport control stratum 150 controls resources of a network 180 on the basis of the transport parameter. If the controlling of the resources is complete, the IMS 140 finally sends the SIP OK command to the first protocol converter 112. The first protocol converter 112 converts the SIP OK command into an RTSP OK command, and then transfers the RTSP OK command to the user terminal 110.

After the protocol converters 112 and 172 respectively transfer and receive the SIP OK command, media setup of RTSP is terminated, and thus protocol conversion is terminated; commands such as “PLAY”, “PAUSE”, and “SCALE”, for trick play, are transmitted without any modification; and finally a RTSP TEARDOWN command is converted into a SIP BYE command, so that a session is terminated.

Also, the first protocol converter 112 may be an independent apparatus, and can be implemented as a partial function of a Proxy Call Session Control Function (P-CSCF) of the IMS 140. The P-CSCF is a first point at which a user accesses an IMS multimedia network. If the first protocol converter 112 is implemented as an independent apparatus, the user terminal 110 and the VOD streaming server 170 can directly receive and transmit a command for trick play data.

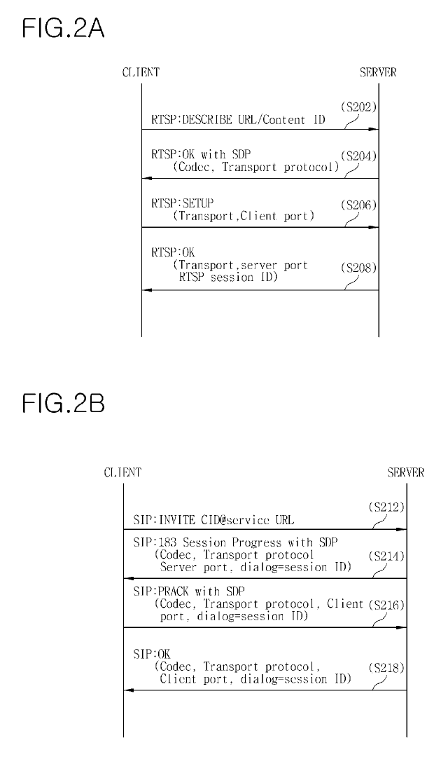

FIG. 2A shows data flow in a media setup method based on an RTSP, according to an embodiment of the present invention.

First, if a client transmits an RTSP: DESCRIBE URL/Content ID message to a server (operation S202), the server transmits RTSP: OK with SDP (Codec, Transport Protocol) message to the client in response to the RTSP:DESCRIBE URL/Content ID message (operation S204). At this time, the client can acquire information about a codec and a transport protocol.

Then, the client transmits a RTSP:SETUP (Transport, Client Port) message to the server (operation S206), and the server transmits a RTSP:OK (Transport, server port, RTSP session ID) message to the client in response to the RTSP:SETUP (Transport, Client Port) message (operation S208). That is, when initial setup is performed between a client and a server, information about a codec, a transport protocol, a transport parameter, a server, and a client port is transmitted and received between the client and the server.

FIG. 2B shows data flow in a media setup method based on SIP, according to an embodiment of the present invention.

First, if a client transmits SIP:INVITE CID@ service URL message to a server (operation S212), the server transmits SIP:183 Session Progressive with SDP (Codec, Transport protocol, Server port, dialog=session ID) message to the client in response to the STP:INVITE CID@ service URL message (operation S214). At this time, the client can acquire information about a codec, a transport protocol, and a server port.

Then, the client transmits SIP:PRACK with SDP (CODEC, Transport protocol, Client port, dialog=session ID) message to the server (operation S216), and the server transmits SIP:OK (CODEC, Transport protocol, Client port, dialog=session ID) message to the client in response to the SIP: PRACK with SDP (CODEC, Transport protocol, Client port, dialog=session ID) message (operation S218). That is, when initial setup is performed between a client and a server, information about a codec, a transport protocol, a transport parameter, a server, and a client port is sent between the client and the server.

In other words, in both protocols illustrated in FIGS. 2A and 2B, the client and server transmit and receive information between themselves about a codec, a transport protocol, a transport parameter, a server, and a client port when the protocols are initially set up, and the protocols will obtain the same parameters with respect to the information. Also, the protocols each generate a session ID.

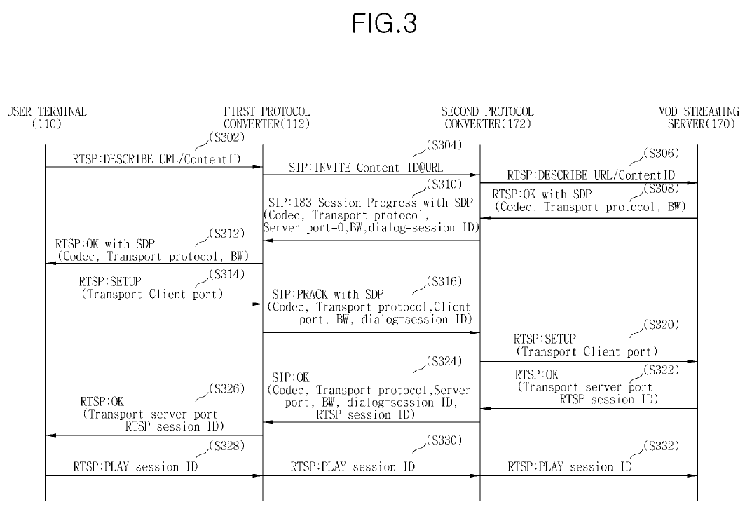

FIG. 3 shows data flow in a method of performing conversion between SIP and RTSP when the RTSP performs media setup, according to an embodiment of the present invention.

Referring to FIGS. 1 and 3, when the user terminal 110 selects a VOD which the user wants to watch through the VOD portal server 120, the user terminal 110 receives a Uniform Resource Locator (URL) and content ID from the VOD portal server 120. The URL indicates a location of a VOD streaming server in which the VOD content selected by the user is stored. The content ID is an identifier of the VOD content. The user terminal 110 performs media setup of an RTSP on the basis of the content ID.

First, if the user terminal 110 requests information about a codec, bandwidth and transport protocol of content selected by the user using a DESCRIBE command of the RTSP (operation S302), the first protocol converter 112 receives the request, converts the request into an SIP INVITE command, and transmits the SIP INVITE command to the corresponding second protocol converter 172 through the IMS 140 (operation S304).

The second protocol converter 172 converts the SIP INVITE command into an RTSP DESCRIBE command, and transports the RTSP DESCRIBE command to the VOD streaming server 170 (operation S306).

Accordingly, the VOD streaming server 170 transmits an RTSP: OK with SDP (Codec, Transport, BW) message to the second protocol converter 172 in response to the RTSP DESCRIBE command (operation S308), and the second protocol converter 172 converts the RTSP: OK with SDP (Codec, Tansport, BW) message into SIP:183 Session Progress with SDP (Codec, Transport Protocol, Server port=0, BW, dialog=session ID) message through the SIP, and transports the SIP:183 Session Progress with SDP (Codec, Transport Protocol, Server port=0, BW, dialog=session ID) message to the corresponding first protocol converter 112 through the IMS 140 (operation S310). The first protocol converter 112 converts the SIP:183 Session Progress with SDP (Codec, Transport Protocol, Server port=0, BW, dialog=session ID) message into an RTSP:OK with SDP (Codec, Transport protocol, BW) message, using the RTSP (operation S312).

In this manner, the user terminal 110 and the VOD streaming server 170 communicate with each other using only the RTSP, thereby completing a session setup process of the IMS 140. In more detail, if the user terminal 110 transmits an RTSP:SETUP (Transport, Client port) message to the first protocol converter 112 (operation S314), the first protocol converter 112 converts the RTSP:SETUP (Transport, Client port) message into SIP: PRACK with SDP(CODEC, Transport protocol. Client port, BW, dialog=session ID) message, and transmits the SIP: PRACK with SDP(CODEC, Transport protocol. Client port, BW, dialog=session ID) message to the corresponding second protocol converter 172 (operation S316). Then, the second protocol converter 172 generates and transmits the RTSP:SETUP (Transport, Client port) message to the VOD streaming server 170 (operation S320).

The VOD streaming server 170 transmits an RTSP:OK (Transport, server port, RTSP session ID) message to the second protocol converter 172 in response to the RTSP:SETUP (Transport, Client port) message (operation S322). The second protocol converter 172 converts the RTSP:OK (Transport, server port, RTSP session ID) message into an SIP OK (CODEC, Transport protocol, Server port, BW, dialog=session ID, RTSP session ID) message, and transmits the SIP OK (CODEC, Transport protocol, Server port, BW, dialog=session ID, RTSP session ID) message to the first protocol converter 112 (operation S324). The first protocol converter 112 converts the SIP OK (CODEC, Transport protocol, Server port, BW, dialog=session ID, RTSP session ID) message into an RTSP:OK (Transport, server port, RTSP session ID) message and transports the RTSP:OK (Transport, server port, RTSP session ID) message to the user terminal 110 (operation S326).

In this process, a session ID of the RTSP is created when the VOD streaming server 170 transmits an OK message in response to setup of the RTSP. The session ID is transmitted to the user terminal 110, and the second protocol converter 172 adds the session ID to an SIP message.

Thus, if the user terminal 110 receives the OK message for setup of the RTSP (operation S326), the user terminal 110 sends a PLAY command for controlling reproduction of the media (operation S328) to the protocol converters 112 and 172, and the protocol converters 112 and 172 stop performing protocol conversion but perform forwarding (operations S330 and S332). If the protocol converters 112 and 172 are implemented as an independent entity without being implemented in the user terminal 110 or the VOD streaming server 170, the user terminal 110 and the VOD streaming server 170 can communicate directly with each other using the RTSP after media setup is complete. In this case, the protocol converters 112 and 172 have to have functions for the process.

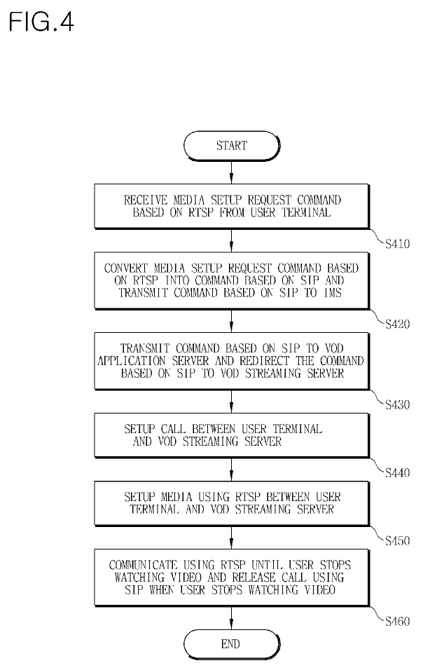

FIG. 4 is a flowchart of a method of providing a VOD service, according to an embodiment of the present invention.

Referring to FIGS. 1 and 4, first, a media setup request is received using the RTSP from the user terminal 110 (operation S410), the media setup request based on the RTSP is converted into an SIP command and then the SIP command is transmitted to the IMS 140 (operation S420). For these operations, a protocol converter for protocol conversion between the SIP and RTSP is needed.

If the IMS 140 transmits the SIP command to the VOD application server 130, the VOD application server 130 redirects the SIP command to the VOD streaming server 170 (operation S430). Thus, call setup between the user terminal 110 and the VOD streaming server 170 is complete (operation S440).

Then, media is set up using the RTSP between the user terminal 110 and the VOD streaming server 170 (operation S450). Details for media setup have been described above with reference to FIG. 3. Thereafter, controlling of reproduction of media, such as a PLAY command, is performed by the RTSP until a user stops watching video which he or she has selected, and call release is performed by the SIP through the IMS 140 when he or she stops watching the video (operation S460).

Meanwhile, the VOD service providing method described above can be embodied in a computer program. Codes and code segments encompassing the program can be easily inferred by a skilled computer programmer in the art. The program can be stored in computer readable media, and read and executed by a computer, thereby implementing the VOD service providing method. The media can include magnetic media such as a floppy disk or a hard disk and optical media such as a CD-ROM or a digital video disc (DVD). Also, the program can be transmitted by carrier waves such as the Internet.

The present invention can be utilized to provide a video-on-demand service in an IPTV system.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A method of providing a video-on-demand (VOD) service, comprising:
receiving a media setup request message from a user terminal, converting the media setup request message using a second protocol which is different from a first protocol on which the media setup request message is based, transmitting the converted media setup request message through a transmission network, receiving a response message in response to the converted media setup request message through the transmission network, converting the response message using the first protocol on which the media setup request message is based, and transmitting the response message to the user terminal; and
converting the converted media setup request message received through the transmission network using the first protocol on which the media setup request message is based, transmitting the newly converted media setup request message to a VOD streaming server, converting the response message from the VOD streaming server using the second protocol, and transmitting the converted response message through the transmission network.

2. The method of claim 1, further comprising controlling reproduction of media requested by the user terminal according to the first protocol after the media setup is performed.

3. The method of claim 1, wherein the first protocol is a Realtime Streaming Protocol (RTSP) and the second protocol is Session Initiation Protocol (SIP).

4. The method of claim 1, wherein the receiving and converting of the media setup request message and the response message comprises:
receiving the media setup request message using a Realtime Streaming Protocol (RTSP) from the user terminal;
converting the media setup request message based on the RTSP into a message based on Session Initiation Protocol (SIP), and transmitting the message based on the SIP to an Internet Protocol (IP) multimedia subsystem; and
transmitting the message based on the SIP to a VOD application server to select the VOD streaming server in the IP multimedia sub system, and redirecting the message based on the SIP to the VOD streaming server so that the user terminal and the VOD streaming server perform call setup, in the VOD application server.

5. The method of claim 1, wherein the user terminal and the VOD streaming server perform media setup of receiving and transmitting a media parameter and a realtime transmission protocol session ID, using a Realtime Streaming Protocol (RTSP).

6. A protocol conversion apparatus for providing a video-on-demand (VOD) service, comprising:
a first protocol converter converting a media setup request message transmitted from a user terminal using a second protocol which is different from a first protocol on which the media setup request message is based, transmitting the converted media setup request message through a transmission network, converting a response message which responds to the media setup request message, using the first protocol, and transmitting the converted response message to the user terminal; and
a second protocol converter converting the converted media setup request message received through the transmission network using the first protocol, transporting the newly converted media setup request message to a VOD streaming server, converting a response message which responds to the media setup request message, using the second protocol, and transmitting the converted response message through the transmission network.

7. The apparatus of claim 6, wherein the first protocol converter is installed in the user terminal, and the second protocol converter is installed in the VOD streaming server.

8. The apparatus of claim 6, wherein the first protocol converter is installed in a Proxy Call Session Control Function (P-CSCF) of an Internet Protocol (IP) multimedia subsystem.

9. The apparatus of claim 6, wherein the transmission network comprises an Internet Protocol (IP) multimedia subsystem, a VOD application server, and a VOD streaming server; the IP multimedia subsystem receives a media setup request message converted using Session Initiation Protocol (SIP) protocol by the first protocol converter; the VOD application server receives the converted media setup request message based on the SIP from the IP multimedia subsystem and transmits the converted media setup request message based on the SIP to the VOD application server to select a VOD streaming server; and the VOD application server redirects the converted media setup request message to the VOD streaming server so that the user terminal and the VOD streaming server perform call setup.

10. An apparatus for providing a video-on-demand (VOD) service, comprising:
a protocol conversion apparatus performing protocol conversion between Realtime Streaming Protocol (RTSP) and Session Initiation Protocol (SIP);
an Internet Protocol (IP) multimedia subsystem receiving a media setup request message based on the SIP, which is converted by the protocol conversion apparatus; and
a VOD application server receiving the media setup request message based on the SIP from the IP multimedia subsystem, transmitting the media setup request message to a VOD application server to select a VOD streaming server, and redirecting the media setup request message to the VOD streaming server so that the user terminal and the VOD streaming server perform call setup.
